(19) United States
(12) Patent Application Publication
(10) Pub. No.: US 2017/0019718 A1
(43) Pub. Date: Jan. 19, 2017

(54) ADVERTISEMENT DELIVERY SYSTEM

(71) Applicants: Neyhan AKGUN, Istanbul (TR); Behiye AKGUNDUZ, Istanbul (TR); Rana ONAT, Istanbul (TR)

(72) Inventors: BEHIYE AKGUNDUZ, Istanbul (TR); NEYHAN AKGUN, ISTANBUL (TR); RANA ONAT, Istanbul (TR)

(21) Appl. No.: 15/122,176

(22) PCT Filed: Jan. 19, 2015
(86) PCT No.: PCT/TR2015/000019

§ 371 Date: Aug. 28, 2016

(30) Foreign Application Priority Data
Jan. 28, 2014 (TR) 2014/00964

(51) Int. Cl. H04N 21/81; H04N 21/41; H04N 21/434; H04N 21/845; H04N 21/2389; G06Q 30/02; H04N 21/462

(52) U.S. Cl. CPC H04N 21/812; G06Q 30/0272; H04N 21/4126; H04N 21/4622; H04N 21/8456; H04N 21/23892; H04N 21/4345

(57) ABSTRACT

The invention is an advertisement delivery system and a method based on this system. The system comprises a display device, a broadcast server, an advertisement processing server and a capture device that has a capture unit. An identifier data that can uniquely identify an object to be advertised is defined. The identifier data, which corresponds to a product chosen by the advertising party, is embedded into or matched to at least one of the frames of a broadcast content that will be displayed on the display device. While the broadcast content is being displayed on the display unit of the display device, a viewer uses the capture device's capture unit to capture the identifier data. The identifier data is used to pick the advertisement corresponding to the object of interest and the picked advertisement is delivered to the viewer on any smart mobile device or smart television that is available to the viewer without interrupting the broadcast by any advertisement breaks.

### FIELD OF INVENTION

The invention is an advertisement delivery system that provides a television viewer on demand access to information that an advertising party is seeking to deliver about an item that is of interest to the viewer, on smart mobile devices and/or smart televisions without interrupting the broadcast by any advertisement breaks.

### PRIOR ART

Currently, advertising in cable, antenna (terrestrial), satellite broadcast is performed by interrupting the broadcast by advertisement breaks, by allocating a certain portion of the screen for visual messages or by embedding advertisement visuals on top of the broadcast content, to allow the advertising party to communicate their message related to a product within a short time period.

The most common of these three techniques is to interrupt the broadcast by an advertisement break and broadcast the content specifically prepared by a third party to advertise a certain item. This approach leaves no control to the viewer and typically breaks the viewer's concentration. This causes the viewer to lose interest in the interrupted content and change the channel, seriously reducing the effectiveness and impact of the advertisement. Furthermore, repeated advertisement breaks replaying the same message may even cause the viewer to develop a negative prejudice against the product that is being advertised. Finally, the pressure to deliver the right message about an item to be advertised in a short time interval substantially increases the production costs of effective advertisement messages.

Another technique is to allocate a certain portion of the broadcast picture (for example, the bottom portion of the picture or all four sides of the picture after resizing the original broadcast picture) for an advertisement message without interrupting the broadcast content. The allocated area is used to display product promotions in the forms of scrolling text, product logos and visuals for a short time period. Since the quality of the visual information that can be communicated is limited, and viewers are mostly focused on the broadcast content, this advertising technique provides limited impact.

Finally, the developments in digital systems allows embedding stationary advertisement visuals on top of certain allowed portions of the broadcast content without interrupting the broadcast. The final technique is based on using these embedded advertisement visuals, which typically have an artificial look and can only be kept in the broadcast for a short time, to communicate an advertisement message to the viewer. This technique does not interrupt the broadcast, however, can annoy the viewer if the embedded content takes too much space or can fail to effectively deliver the advertisement message otherwise. Both of these cases are undesired scenarios since either the view experience is degraded or the advertisement message is not delivered effectively.

### SHORT DESCRIPTION OF THE INVENTION

The aim of the current invention is to realize an advertisement delivery system that provides a television viewer on demand access to information that an advertising party is seeking to deliver about an item that is of interest to the viewer, on smart mobile devices and/or smart televisions without interrupting the broadcast by any advertisement breaks.

The invention is an advertisement delivery system and a method based on this system. In this context, the invention is a system that delivers advertisements to a viewer based on the viewer's request, over cable, antenna (terrestrial), satellite broadcast, without interrupting the broadcast. The system is based on an identifier data that can uniquely identify an object to be advertised and the advertisement that corresponds to this object. The system transforms this identifier data into such a format that can be resolved by a processing method that is executed on the device(s) available to the viewer while watching the visual broadcast. When the viewer requests to access the advertisement information that belongs to an object that the viewer is interest in, the identifier data is resolved. Then the system uses the resolved identifier to determine the advertisement that corresponds to the object of interest, and delivers the advertisement information to the viewer.

The advertisement delivery system consists of:
A display device that has a receiver unit that can receive cable, antenna (terrestrial), satellite broadcast; a display unit that displays the received broadcast to the viewer; and at least one control unit,
A broadcast server that has a transmitter unit that transmits the broadcast content, which includes the advertisement, to the display device; and an advertisement processing server that has a control unit, a receiver unit, a transmitter unit, and a database; and
A capture device that has a capture unit that can be used by the viewer to capture an identifier data that uniquely identifies an object of interest within the broadcast content that is being displayed by the display unit. The identifier data is a unique reference to an object to be advertised such that the object is visible in the broadcast that will be displayed by the display device in a specific time interval. This identifier data is prepared in advance and either embedded into or matched to at least one of the frames of the broadcast content that will be displayed by the display device.

The advertisement processing server has a database that stores all the objects to be advertised within broadcast as determined by the advertising parties and the identifier data that corresponds to these objects. The advertisement processing server also has a controller unit that either embeds these object identifiers corresponding to the objects to be advertised as determined by the advertising parties, into at least one of the frames of the broadcast content that will be displayed by the display device; or matches these object identifiers corresponding to the objects to be advertised as determined by the advertising parties, with at least one of the frames of the broadcast content that will be displayed by the display device. The advertisement processing server stores the information of the time intervals and the channels on which each of the object(s) to be advertised will appear. The advertisement processing server stores the information about how each object to be advertised will be resolved from its corresponding identifier data and the information necessary to resolve multiple objects for the case where multiple objects to be advertised appear within the same time interval.

The capture device has a control unit that identifies on which broadcast channel the object to be advertised appeared. This control unit processes visual data captured by the capture unit to find out from which broadcast channel it was captured.

The advertisement delivery system has a capture unit that captures a single image or multiple consecutive images (e.g. video) and transmits these image(s) to the advertisement processing server; and an advertisement processing server with a control unit that can identify from which broadcast channel the image(s) was/were captured. If the capture device has enough memory and processing capability, then identification of the broadcast channel, from which the image(s) were captured, is performed locally on the capture device. If the capture device does not have enough memory or processing capability, then the capture device transmits the captured image(s) to the advertisement processing server and identification of the broadcast channel, from which the image(s) was/were captured, is performed on the advertisement processing server.

Capture device has a control unit that detects the time interval(s) during which the object(s) to be advertised is (are) visible within the broadcast. This control unit also extracts the object identifier data corresponding to the object(s) to be advertised.

The advertisement processing server has a control unit that can also extract the object identifier data. If the capture device has enough memory and processing capability, than extraction of the object identifier is performed locally on the capture device. If the capture device does not have enough memory or processing capability, then the capture device transmits the captured data to the advertisement processing server and extraction of the object identifier is performed on the advertisement processing server.

The advertisement processing server delivers the advertisement that corresponds to the object of interest to the capture device. The capture device's control unit uses the information coming from the advertisement processing server to display the advertisement to the viewer. The capture device's control unit uses the viewer's preference to either display the selected advertisement as soon as it is available or store it to be displayed at a later time.

Depending on the viewer's preference, the advertisement can also be viewed on the display unit on which the broadcast content is viewed. The capture device's control unit transmits the information that it either receives or produces to the display device's control unit, to have the advertisement displayed on the display device's display unit.

In case the viewer prefers to view the advertisement as soon as it is available, following the capture device's control unit making a decision, the display device's control unit displays the advertisement in Picture in Picture (PiP) mode, without interrupting the broadcast content. That is, the control unit of the capture device makes a decision on whether the advertisement is to be displayed in the PiP mode or not, and forwards this decision to the control unit of the display device. Based on this decision, the control unit of the display device displays the advertisement in the format and image desired by the viewer.

The display device has a memory unit that can store the advertisement message to be displayed a later time depending on the viewer's preference.

### DETAILED DESCRIPTION OF THE INVENTION

### Description of the Figures

FIG. 1—A block diagram of the advertisement delivery system described herein.

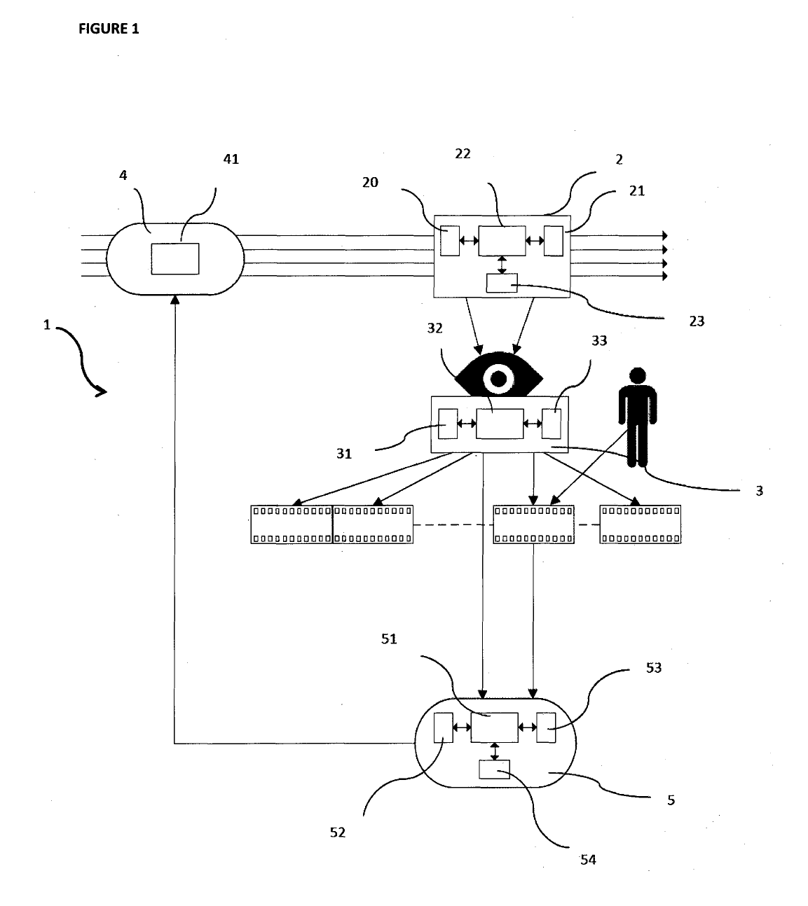

FIG. 2—A flow diagram of the advertisement delivery method based on the advertisement delivery system described herein.

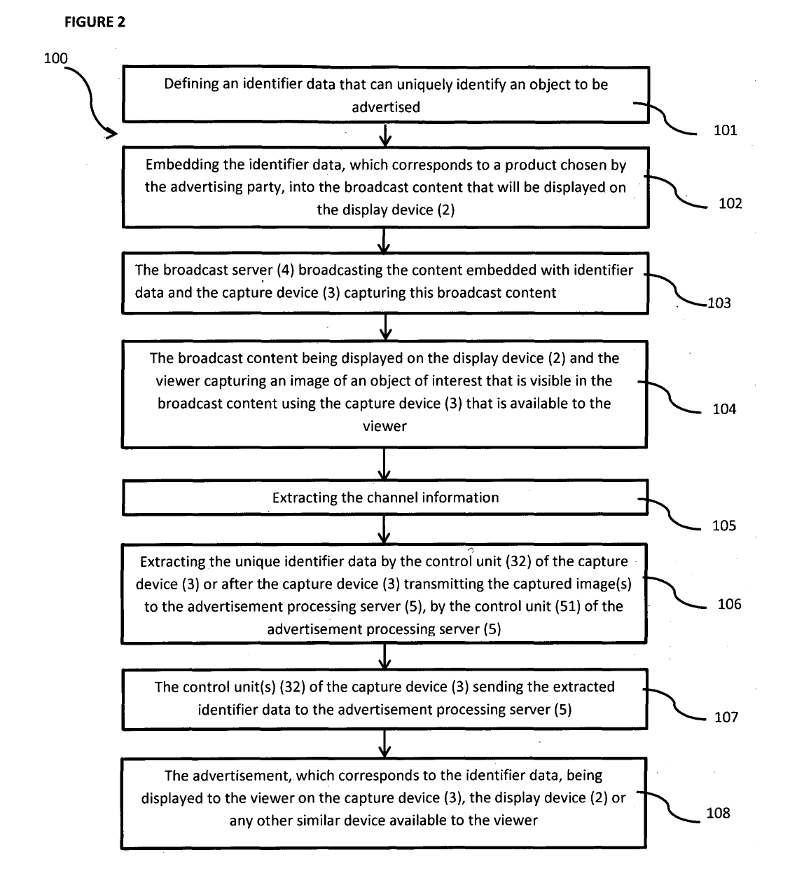

FIG. 3—An exemplary flow diagram illustrating the embedding of the identifiers that are used to identify an object to be advertised into the broadcast content according to the advertisement delivery method that is based on the advertisement delivery system described herein.

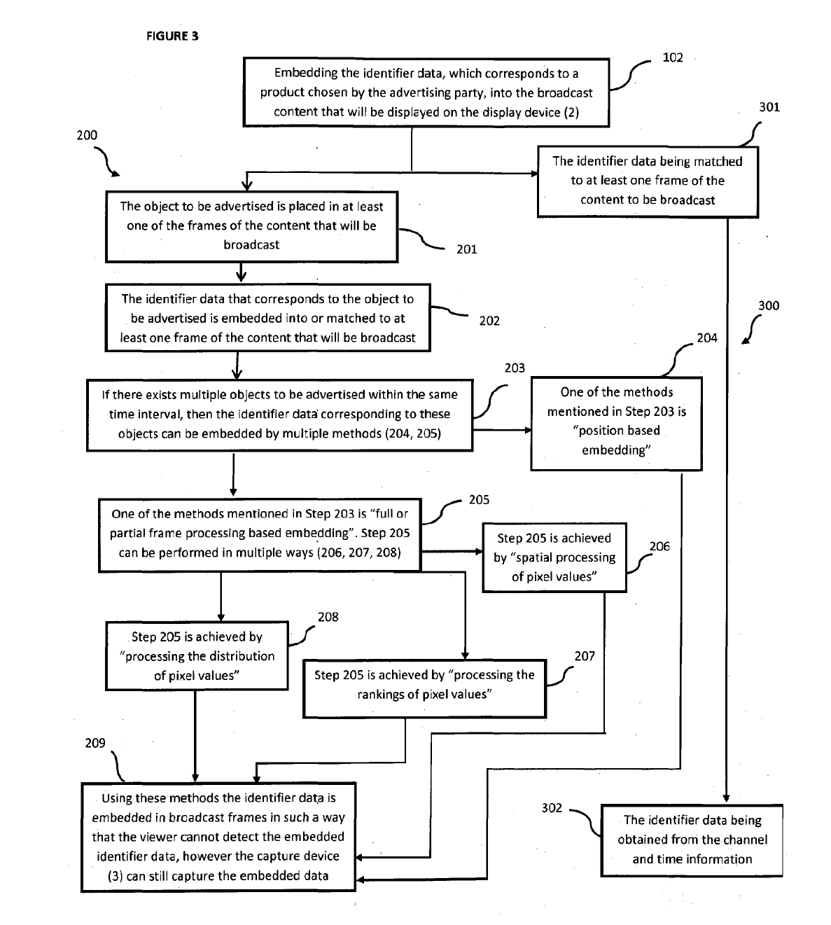

FIG. 4—An exemplary flow diagram illustrating the extraction of broadcast channel information according to the advertisement delivery method that is based on the advertisement delivery system described here.

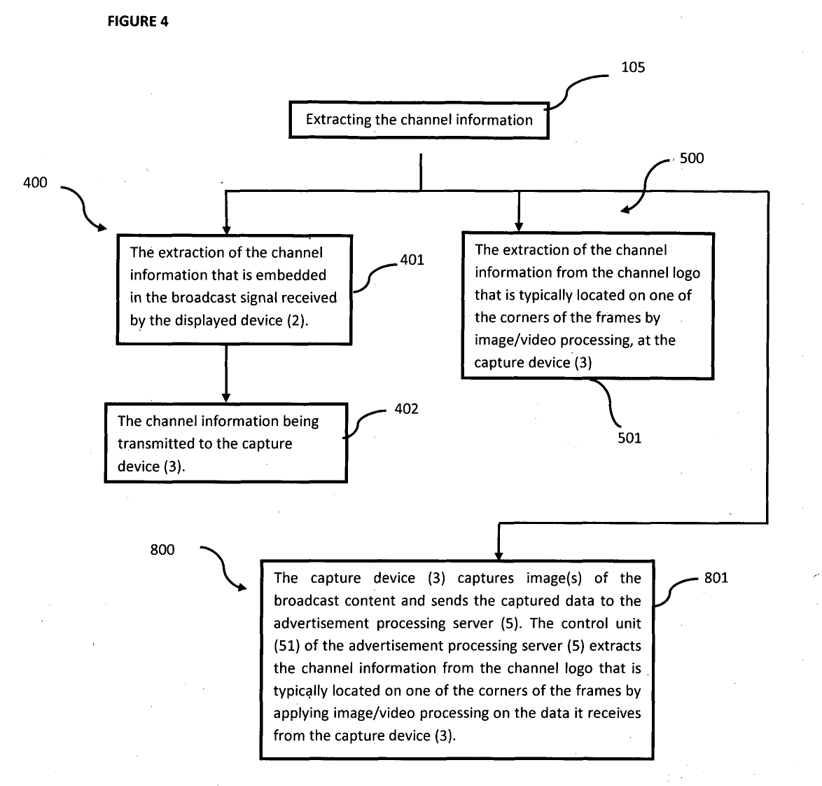

FIG. 5—An exemplary flow diagram illustrating the extraction of the object identifier data by the control unit of the capture device according to the advertisement delivery method that is based on the advertisement delivery system described herein.

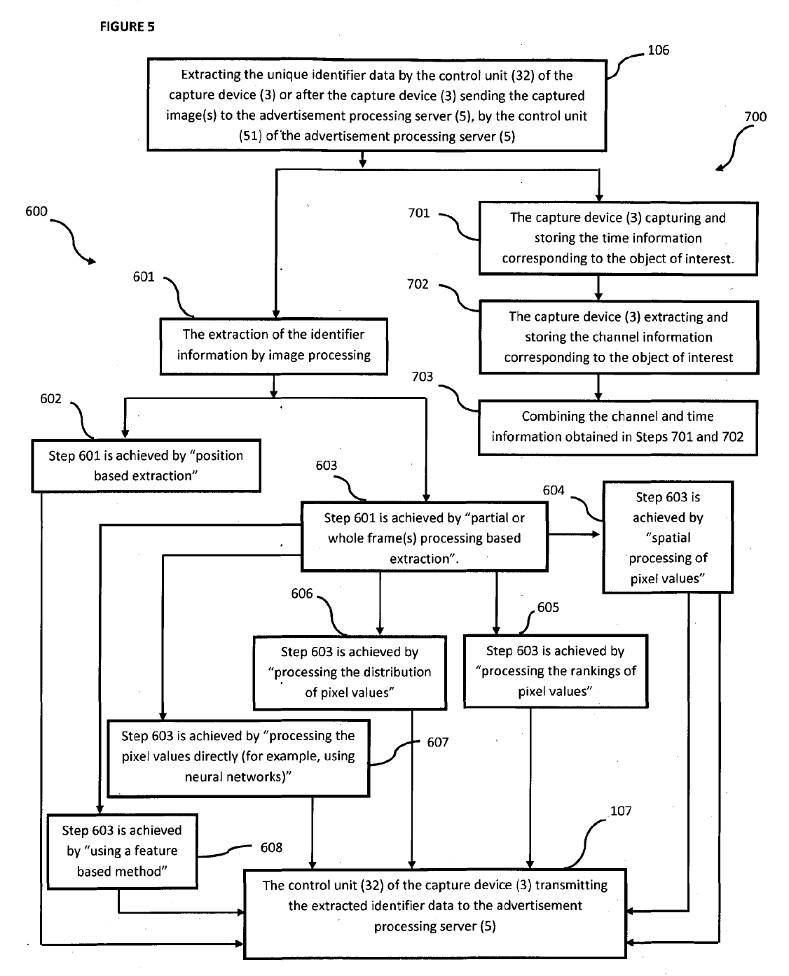

### EXPLANATIONS OF THE REFERENCES IN THE FIGURES

1. System
2. Display device
   20. Receiver unit
   21. Display unit
   22. Control unit
   23. Network unit
3. Capture device
   31. Capture unit
   32. Control unit
   33. Display unit
4. Broadcast server
   41. Transmitter unit
5. Advertisement processing server
   51. Control unit
   52. Receiver unit
   53. Transmitter unit
   54. Database
100. An advertisement delivery method

The subject of the current invention is an advertisement delivery system (1) that consists of a display device (2), a capture device (3), a broadcast server (4) and an advertisement processing server (5).

The capture device (3) is preferably a mobile device.

The display device (2) has a receiver unit (20) that receives cable, antenna (terrestrial), satellite broadcast, a display unit (21) that displays the received broadcast to the viewer, and a control unit (22). The display unit (21) is preferably a display or any visual interface that can be used to display visual content to the viewer. In one embodiment of the present invention, the display device (2) has a network unit that can connect to the Internet.

The capture device (3) has a capture unit (31) that is capable of capturing images, a control unit (32) that is capable of recording the time instances when these images are captured, and capable of processing the captured images; and a display unit (33) that is capable of displaying the advertisement to the viewer. The capture device's control unit (32) is capable of capturing and recording time information. In one embodiment of the present invention, still image or multiple consecutive still images (video) are captured along with the time information, and in one alternative of this embodiment of the present invention, the capture device (3) is a camera. The capture device (3) also has a unique identifier such as an IP (Internet Protocol) address or a MAC ID (Media Access Control Identifier). In different embodiments of the present invention, the capture device (3) can be a smart television, a smart phone, a laptop computer, a tablet computer or a wearable device such as Google Glass or a smart watch.

The broadcast server (4) has a transmitter unit (41) that transmits the broadcast content, within which the objects to be advertised are visible, to the display device (2). Any processing that is required to embed the identifier data that corresponds to an object to be advertised into the broadcast content is, performed by the parties that either produce or broadcast the content.

In the system (1) the advertisement processing server (5) has a control unit (51), a transmitter unit (53), a receiver unit (52) and a database (54) that is used to store the objects to be advertised within the broadcast and the identifier data that correspond to these objects. The system times used by the broadcast server (4) and the advertisement processing server (5) are synchronized. In one embodiment of the invention, the broadcast server (4) includes the advertisement processing server (5). The advertisement processing server (5) receives time information from the capture device (3). The advertisement processing server (5) stores the advertisement information and channel information that corresponds to the received time. In one embodiment of the invention, the advertisement processing server (5) receives the unique identification information that belong to the viewers, and dynamically builds viewer profile information.

The first step of the invention is having object(s) to be advertised visible in frames of the broadcast television content displayed on the display device. The next step is to define the identifier information that can be used to resolve an object to be advertised. If there exists multiple objects to be advertised within the same frame(s) of the broadcast content, then each object to be advertised has an identifier that can uniquely resolve that specific object.

The advertising party selects objects to be advertised within the broadcast, and the identifiers to be used to resolve these objects are defined and processed into the broadcast. This process is performed either by embedding the identifier data into at least one frame of the broadcast content or by matching the identifier data to at least one frame of the broadcast content. The advertisement processing server (5) stores the broadcast time and channel information for all objects to be advertised. For objects that appear on the same channel and in the same time interval, the advertisement processing server (5) stores additional necessary information that can be used to resolve a specific object.

The identifier data that is embedded into video frames is kept below the level that can be visually perceived by the viewer, and above the level that is required by the capture device (3) to visually capture the identifier data. Preferably, at least one frame within any group of consecutive frames that includes a predetermined number of frames is embedded with identifier information. If the viewer's capture device's capture capability is low and if this results in failing to capture identifier data, then the number of frames embedded with identifier data is increased while still staying below the level that can be visually detected by the viewer. This makes it possible to use smart phones with lower capture capabilities as capture devices.

The identifier data that belongs to an object to be advertised is embedded into or matched to at least one frame of the broadcast content, within which the object to be advertised is present at a reasonable size. These embedded or matched frames can include identifier data that belongs to one or multiple objects to be advertised. This identifier data is captured by the capture unit (31) (for example a camera) of the capture device (3) by taking a picture of the broadcast content. Here, an object being present at a reasonable size means that the object's size on the display unit (21) is any size that is sufficient to attract the viewer's interest. As a result, the advertising party and/or the broadcasting party decides on the scenes where the identifier data is to be embedded or matched.

The object identifier data that corresponds to object(s) to be advertised during broadcast can be embedded into or matched to broadcast frames by multiple methods.

One of these methods is “position based embedding”. In this method, the spatial location of an object to be advertised within one or multiple frames constitutes part or whole of the identifier information that is to be used to resolve this object.

Another one of these methods is full or partial frame(s) processing based embedding. There exist multiple alternatives to realize this method. One of these alternatives is spatial processing (filtering) of some or all pixels within frame(s) (for example, using Haar like spatial filters). Another alternative is processing the distribution of values (for example, using histogram processing) of some or all of the pixels within frame(s). Another alternative is processing the ranking of values (for example, using filters based on ranking statistics) of some or all pixels within frame(s).

Using these methods the identifier data is embedded in broadcast frames in such a way that the viewer cannot detect the embedded identifier data, however the capture device (3) can still capture the embedded data.

The invention is based on capturing the identifier data corresponding to an object that is chosen by the advertising party to be advertised during broadcast, by processing the frames that are displayed on the display device (2). The identifier data is captured by the capture unit (31). In one embodiment of the invention, the capture unit (31) is a camera. In this embodiment, the viewer captures a still image or multiple still images of the broadcast content during a, time interval in which the object to be advertised is visible. The capture device (3) then stores this/these image(s) on the capture device (3). In another embodiment of the invention, the capture unit (31) is only capable of capturing the time and the channel information. In this embodiment of the invention, the time and channel, in which the object is present in the broadcast content, are stored on the capture device (3).

Next, the control unit (32) of the capture device (3) detects on which channel the object of interest appears. The control unit (32) of the capture device (3) uses one or more of the methods listed below (collaboratively) to extract the channel information and combines the extracted channel information with the time information.
a. Display device (2), for instance a television, extracts the channel information that is embedded in the broadcast signal, and transmits this information to the capture device (3). The control unit (32) of the capture device (3) combines this channel information with the time information it captures.
b. The channel information is extracted from broadcast frames by using the channel logo that is typically located on the corners of the broadcast video frames, by image/video processing. The extracted channel information is then combined with the time information that is obtained. These processing steps are performed by the control unit (32) of the capture device (3).
c. The channel information is extracted from broadcast video frames by using the channel logo that is typically located on the corners of the broadcast video frames, by image/video processing. The extracted channel information is then combined with the time information that is obtained by the capture device (3). The extraction of channel information is performed by the control unit (51) of the advertisement processing server (5) by using an image or multiple images of the broadcast content that are captured by the capture device (3) and transmitted to the advertisement processing server (5).

Once the time and channel in which the object of interest appeared are identified, the identifier data that is used to uniquely identify the object of interest is extracted either by the control unit (32) of the capture device (3) or by the control unit (51) of the advertisement processing server (5) upon the capture unit (3) transmitting the captured still image or multiple still images to the advertisement processing server (5), by using two methods.

The first method extracts the identifier information by processing the captured image of the broadcast content. There are multiple methods to process the captured data to extract the identifier information. These methods are as follows:
Position based extraction is based on extracting unique identifier data from the spatial location of the object(s) of interest within a single or multiple frames.
Partial or whole frame processing based extraction can be performed in multiple ways. These are: spatial processing (filtering) of some or all pixels within frame(s) (for example, using Haar like spatial filters), processing the distribution of values (for example, using histogram processing) of some or all of the pixels within frame(s), processing the ranking of values (for example, using filters based on ranking statistics) of some or all pixels within frame(s) to extract the unique identifier.
Using pixel values directly to extract the unique identifier as done in neural networks based approaches.
Using a feature based method. Feature based methods can be performed using single-scale or multi-scale approach. (for example, using Haar like features as input to a support vector machine)

The subject of the current invention, the advertisement delivery system (1) and the method (100) based on this system, are independent of the method used to achieve the extraction of the unique identifier information from a single frame or multiple frames. Any suitable method that is available can be used to achieve the extraction of the unique identifier data from a single frame or multiple frames. The obtained identifier data is transmitted to the advertisement processing server (5).

In the second method, the control unit (32) of the capture device (3) identifies on which channel the object of interest appears, and detects and records the time of appearance of the object of interest. Then the channel and time information obtained by the capture device (3) are transmitted to the advertisement processing server (5).

In one embodiment of the invention, the extraction of the channel information is performed by the advertisement processing server (5) after the capture device (3) transmits the still image(s) that it captured to the advertisement processing server (5). Once the channel information is available, the advertisement message/information message that corresponds to this channel information can be delivered. The advertisement processing server (5) uses this information to extract the unique identifier that is used to resolve the object of interest, and transmits the chosen advertisement message to the capture device (3).

The advertisement information that is delivered by the advertisement processing server (5) is displayed to the viewer on the capture device (3) or on the display device (2).

In the embodiment where the capture device (3) is used to display the advertisement message, the advertisement message can either be displayed as soon as it is available or can be stored on the capture device (3) to be displayed at a later time. If the message is to be displayed at a later time, it is stored on a memory that is available on the capture device (3). In one embodiment of the invention where the message is to be displayed at a later time, the message can be stored on cloud storage. The viewer can access the advertisement messages about the objects that the viewer is interested in at a later time, and the capture device (3) displays these messages in whichever order the viewer prefers.

In another alternative of this embodiment of the invention, where the advertisement message is to be displayed by the display device (2), the control unit (32) of the capture device (3) extracts the unique identifier data and transmits the extracted identifier data to the display device (2). The control unit (22) of the display device (2) matches the identifier data it receives with the advertisement message via the advertisement processing server (5). If the viewer prefers to view the message as soon as it is available, the display device (2) displays the message to the viewer using the PiP (Picture in Picture) mode. Depending on the viewer's preference, the obtained advertisement message can also be stored on a memory unit that is available on the display device (2) to be displayed at a later time.

The control units used in the invention (22, 32, 51) can be ARM (advanced RISC machine), CPU (central processing unit), APU (accelerated processing unit), GPU (graphics processing unit), FPGA, (field programmable gate array), DSP (digital signal processor) or any other similar processor or coprocessor.

The method (100) based on the advertisement delivery system (1) comprises the following steps:
101—Defining an identifier data that can uniquely identify an object to be advertised,
102—Embedding the identifier data, which corresponds to a product chosen by the advertising party, into the broadcast content that will be displayed on the display device (2),
103—The broadcast server (4) broadcasting the content embedded with identifier data and the display device (2) receiving this broadcast content,
104—The broadcast content being displayed on the display device (2) and the viewer capturing an image of an object of interest that is visible in the broadcast content using the capture device (3) that is available to the viewer,
105—Extracting the channel information,
106—Extracting the unique identifier data by the control unit (32) of the capture device (3) or after the capture device (3) transmitting the captured image(s) to the advertisement processing server (5), by the control unit (51) of the advertisement processing server (5),
107—The control unit (32) of the capture device (3) transmitting the extracted identifier data to the advertisement processing server (5),
108—The advertisement, which corresponds to the identifier data, being displayed to the viewer on the capture device (3), the display device (2) or any other similar device available to the viewer.

“Step 102—Embedding the identifier data, which corresponds to a product chosen by the advertising party, into the broadcast content that will be displayed on the display device (2)” of the method (100) can be achieved by two methods (200 and/or 300). One of these methods (200) consists of the following steps:
201—The object to be advertised is placed in at least one of the frames of the content that will be broadcast.
202—The identifier data that corresponds to the object to be advertised is embedded into or matched to at least one frame of the content that will be broadcast.
203—If there exists multiple objects to be advertised within the same time interval, then the identifier data corresponding to these objects can be embedded by multiple methods (204, 205).
204—One of the methods mentioned in Step 203 is “position based embedding”.
205—One of the methods mentioned in Step 203 is “full or partial frame processing based embedding”. Step 205 can be performed in multiple ways (206, 207, 208).
206—Step 205 is achieved by “spatial processing of pixel values”.
207—Step 205 is achieved by “processing the rankings of pixel values”.
208—Step 205 is achieved by “processing the distribution of pixel values”.
209—Using these methods the identifier data is embedded in broadcast frames in such a way that the viewer cannot detect the embedded identifier data, however the capture device (3) can still capture the embedded data.

The second method (300) that can be used to achieve “Step 102—Embedding the identifier data, which corresponds to a product chosen by the advertising party, into the broadcast content that will be displayed on the display device 2)” of the method (100) consists of the following steps:
301—The identifier data being matched to at least one frame of the content to be broadcast.
302—The identifier data being obtained from the channel and time information.

The “Step 105—Extracting the channel information” of the method (100) can be achieved by three different methods (400, 500, 800). The first one of these methods (400) consists of the following steps:
401—The extraction of the channel information that is embedded in the broadcast signal received by the displayed device (2).
402—The channel information being transmitted to the capture device (3).

The second one of the methods (500) that can be used to achieve “Step 105—Extracting the channel information” of the method (100) consists of the following step:

501—The extraction of the channel information from the channel logo that is typically located on one of the corners of the frames by image/video processing, at the capture device (3)

The third one of the methods (800) that can be used to achieve the “Step 105—Extracting the channel information” of the method (100) consists of the following step:
801—The capture device (3) captures image(s) of the broadcast content and transmits the captured data to the advertisement processing server (5). The control unit (51) of the advertisement processing server (5) extracts the channel information from the channel logo that is typically located on one of the corners of the frames by applying image/video processing on the data it receives from the capture device (3).

The “Step 106—Extracting the unique identifier data by the control unit (32) of the capture device (3) or after the capture device (3) transmitting the captured image(s) to the advertisement processing server (5), by the control unit (51) of the advertisement processing server (5)” of the method (100) can be achieved by two different methods (600, 700). The first one of these methods (600) consists of the following steps:
601—The extraction of the identifier information by image processing. Step 601 is achieved by two methods (602, 603).
602—The first method to achieve Step 601 is “position based extraction”.
603—The second method to achieve Step 601 is “partial or whole frame(s) processing based extraction”. Step 603 can be achieved in multiple ways (604, 605, 606, 607, 608).
604—Step 603 is achieved by “spatial processing of pixel values”,
605—Step 603 is achieved by “processing the rankings of pixel values”,
606—Step 603 is achieved by “processing the distribution of pixel values”,
607—Step 603 is achieved by “processing the pixel values directly (for example, using neural networks)”,
608—Step 603 is achieved by “using a feature based method”.

The second method (700) that can be used to achieve “Step 106—Extracting the unique identifier data by the control unit (32) of the capture device (3) or after the capture device (3) transmitting the captured image(s) to the advertisement processing server (5), by the control unit (51) of the advertisement processing server (5)” of the method (100) consists of the following steps:
701—The capture device (3) capturing and storing the time information corresponding to the object of interest.
702—The capture device (3) extracting and storing the channel information corresponding to the object of interest.
703—Combining the channel and time information obtained in Steps 701 and 702.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. An advertisement delivery system (1) comprising: a display device (2) that has a receiver unit (20) for receiving cable, antenna (terrestrial) and/or satellite broadcast, a display unit (21) for displaying the received broadcast to the viewer, and at least one control unit (22);
a broadcast server (4) that has a transmitter unit (41) for transmitting the advertisement to the display device (2);
an advertisement processing server (5) that has a control unit (51), a receiver unit (52), a transmitter unit (53) and a database (54); and is characterized by an identifier data that is prepared in advance and either embedded into or matched to at least one of the frames of the broadcast content that will be displayed on the display device (2); and a capture device (3) that has a capture unit (31) for capturing the identifier data from the display unit (21); where the identifier data is a unique reference to an object to be advertised such that the object is visible in the broadcast that will be displayed on the display device (2) in a specific time interval.

2. The system (1) of claim 1, where the system is characterized by an advertisement processing server (5) that has a database (54) storing the objects to be advertised during the broadcast as selected by the advertising parties and the identifier data that corresponds to these objects to be advertised.

3. The system (1) of claim 2, where the system is characterized by an advertisement processing server (5) with a control unit (51) that embeds the identifier data, which corresponds to the objects to be advertised as chosen by the advertising parties, into at least one of the frames of the broadcast content that will be displayed on the display device (2); or matches the identifier data, which corresponds to the objects to be advertised as chosen by the advertising parties, to at least one of the frames of the broadcast content that will be displayed on the display device (2).

4. The system (1) of claim 3, where the system is characterized by an advertisement processing server (5) that stores the time and channel on which the object(s) to be advertised will appear in the broadcast.

5. The system (1) of claim 4, where the system is characterized by an advertisement processing server (5) that stores the information that is used to identify the object to be advertised and resolve a specific object of interest in case there exist multiple objects to be advertised present within the same time interval.

6. The system (1) of claim 1, where the system is characterized by a capture device (3) that has a control unit (32) that detects on which channel the object to be advertised appears.

7. The system (1) of claim 1, where the system is characterized by a capture device (3) that transmits single image or multiple consecutive images (video) to the advertisement processing server (5), and an advertisement processing server (5) that has a control unit (51) that uses the received single image or multiple consecutive images (video) to detect on which channel the object to be advertised appears.

8. The system (1) of claim 6, where the system is characterized by a capture device (3) that has a control unit (32) that detects the time interval in which the object to be advertised appears within the broadcast.

9. The system (1) of claim 6, where the system is characterized by a control unit (32) that extracts the identifier data, which corresponds to an object to be advertised.

10. The system (1) of claim 6, where the system is characterized by a control unit (51) that extracts the identifier data, which corresponds to an object to be advertised.

11. The system (1) of claim 8, where the system is characterized by an advertisement processing server (5) that transmits the advertisement message corresponding to the object of interest to the capture device (3).

12. The system (1) of claim 11, where the system is characterized by a control unit (32) that displays the advertisement/information message to the viewer on the capture device (3), using the information received from the advertisement processing server (5).

13. The system (1) of claim 12, where the system is characterized by a control unit (32) that displays the chosen advertisement message to the viewer on the display unit (33) of the capture device (3) as soon as the advertisement becomes available or stores the advertisement to be displayed at a later time based on the viewer's preference.

14. The system (1) of claim 13, where the system is characterized by a control unit (32) that transmits the information it captures and/or generates to the control unit (22) of the display device (2) to have the advertisement message displayed on the display unit (21).

15. The system (1) of claim 14, where the system is characterized by a display device (2) with a control unit (22)′ that, based on the control unit (32) being used to make the decision, displays the advertisement to the viewer using the PiP (Picture in Picture) mode on the display unit (21) without interrupting the broadcast.

16. The system (1) of claim 14, where the system is characterized by a display device (2) with a control unit (22) which stores the advertisement on a memory that is available on the display device (2), based on the viewer's choice to view the advertisement at a later time.

17. The system (1) of claim 1, where the system is characterized by control units (22, 32, 51) which can be any processor or coprocessor such as ARM (advanced RISC machine) processor, CPU (central processing unit), APU (accelerated processing unit), GPU (graphic processing unit), FPGA (field programmable gate array), or DSP (digital signal processor).

18. An advertisement delivery method (100) based on the system (1) of claim 1 comprising: Defining an identifier data that can uniquely identify an object to be advertised (101),
Embedding the identifier data, which corresponds to a product chosen by the advertising party, into the broadcast content that will be displayed on the display device (2) (102),
The broadcast server (4) broadcasting the content embedded with identifier data and the capture device (3) capturing this broadcast content (103),
The broadcast content being displayed on the display device (2) and the viewer capturing an image of an object of interest that is visible in the broadcast content using the capture device (3) that is available to the viewer (104), Extracting the channel information (105),
Extracting the unique identifier data by the control unit (32) of the capture device (3) or after the capture device (3) transmitting the captured image(s) to the advertisement processing server (5), by the control unit (51) of the advertisement processing server (5) (106),
The control unit (32) of the capture device (3) transmitting the extracted identifier data to the advertisement processing server (5) (107),
The advertisement, which corresponds to the identifier data, being displayed to the viewer on the capture device (3), the display device (2) or any other similar device available to the viewer (108).

19. The method (100) of claim 18, where Step 102 “Embedding the identifier data, which corresponds to a product chosen by the advertising party, into the broadcast content that will be displayed on the display device (2)” is comprising:
The object to be advertised is placed in at least one of the frames of the content that will be broadcast (201),
The identifier data that corresponds to the object to be advertised is embedded into or matched to at least one frame of the content that will be broadcast (202),
If there exists multiple objects to be advertised within the same time interval, then the identifier data corresponding to these objects can be embedded by multiple methods (203),
One of the methods mentioned in Step 203 is position based embedding (204),
One of the methods mentioned in Step 203 is full or partial frame processing based embedding. The full or partial frame processing based embedding can be achieved by multiple methods (205),
Step 205 is performed by “spatial processing of pixel values (206)” and/or “processing the rankings of pixel values (207)” and/or “processing the distribution of pixel values (208)”.
Using these methods the identifier data is embedded in broadcast frames in such a way that the viewer cannot detect the embedded identifier data, however the capture device (3) can still capture the embedded data (209).

20. The method (100) of claim 18, where Step 102 “Embedding the identifier data, which corresponds to a product chosen by the advertising party, into the broadcast content that will be displayed on the display device (2)” is comprising:
The identifier data being matched to at least one frame of the content to be broadcast (301).
The identifier data being obtained from the channel and time information (302).

21. The method (100) of claim 19, where Step 105 “extracting the channel information” is comprising:
The extraction of the channel information that is embedded in the broadcast signal received by the displayed device (2) (401).
The channel information being transmitted to the capture device (3) (402).

22. The method (100) of claim 19, where Step 105 “extracting the channel information” is comprising:
The extraction of the channel information from the channel logo that is typically located on one of the corners of the frames by image/video processing, at the capture device (3) (501).

23. The method (100) of claim 19, where Step 105 “extracting the channel information” is comprising:
The capture device (3) captures image(s) of the broadcast content and transmits the captured data to the advertisement processing server (5). The control unit (51) of the advertisement processing server (5) extracts the channel information from the channel logo that is typically located on one of the corners of the frames by applying image/video processing on the data it receives from the capture device (3) (801).

24. The method (100) of claim 21, where Step 106 “Extracting the unique identifier data by the control unit (32) of the capture device (3) or after the capture device (3) transmitting the captured image(s) to the advertisement processing server (5), by the control unit (51) of the advertisement processing server (5)” is comprising: —The extraction of the identifier information by image processing (601).
Step 601 is achieved by “position based extraction (602)” and/or “partial or whole frame processing based extraction (603)”.
Step 603 is performed by “spatial processing of pixel values
(604)” and/or “processing the rankings of pixel values
(605)” and/or “processing the distribution of pixel values
(606)” and/or “using the pixel values directly, for example, using neural networks (607)” and/or “using a feature based method (608)”.

25. The method (100) of claim 21, where Step 106 “Extracting the unique identifier data by the control unit (32) of the capture device (3) or after the capture device (3) transmitting the captured image(s) to the advertisement processing server (5), by the control unit (51) of the advertisement processing server (5)” is comprising:
The capture device (3) capturing and storing the time information corresponding to the object of interest (701)
The capture device (3) extracting and storing the channel information corresponding to the object of interest (702)
Combining the channel and time information obtained in Steps 701 and 702 (703).
